(19) United States
(12) Patent Application Publication
(10) Pub. No.: US 2010/0053972 A1
(43) Pub. Date: Mar. 4, 2010

(54) LIQUID CRYSTAL POLYESTER RESIN COMPOSITION HAVING EXCELLENT LIGHT REFLECTANCE AND STRENGTH

(75) Inventor: Toshio Nakayama, Kanagawa (JP)

Correspondence Address: SENNIGER POWERS LLP, 100 NORTH BROADWAY, 17TH FLOOR, ST LOUIS, MO, 63102, US

(73) Assignee: NIPPON OIL CORPORATION, Tokyo (JP)

(21) Appl. No.: 12/564,354

(22) Filed: Sep. 22, 2009

(30) Foreign Application Priority Data
Mar. 23, 2007 (JP) 2007077024
Mar. 18, 2009 (JP) PCT/JP2008/055617

(51) Int. Cl. F21V 7/22; C09K 19/06

(52) U.S. Cl. 362/296.01; 252/299.6

(57) ABSTRACT

A resin composition obtained by melt-kneading a wholly aromatic thermotropic liquid crystal polyester and titanium oxide particles maintains the polyester heat resistance and moldability, and achieves white light reflectance and weld portion mechanical strength. The composition includes 100 parts by mass of a wholly aromatic thermotropic liquid crystal polyester, 8 to 42 parts by mass of titanium oxide particles formed by surface treating 97 to 85 mass % of titanium oxide obtained by a method including roasting with 3 to 15 mass % of aluminum oxide, 25 to 50 parts by mass of glass fibers, and 0 to 8 parts by mass of other inorganic fillers. The composition is obtained by undergoing a melt-kneading step including feeding at least a part of the glass fibers using a twin screw extruder from a position which is 30% or more downstream based on a total length of a cylinder of the twin screw extruder.

### CROSS-REFERENCE TO RELATED APPLICATIONS

Priority is claimed to WIPO Patent Application PCT/JP2008/055617 filed Mar. 18, 2009, and Japanese Patent Application 2007-077024 filed Mar. 23, 2007, both of which are incorporated by reference.

### BACKGROUND

The present invention relates to a wholly aromatic thermotropic liquid crystal polyester resin composition having excellent heat resistance and moldability, from which a molded product having excellent reflectance of light in a specific wavelength and excellent weld portion strength can be obtained. Furthermore, the present invention relates to an injection molded product of such wholly aromatic thermotropic liquid crystal polyester resin composition, and an optical device for which the molded product is used. More particularly, the present invention relates to a product in which the optical device uses a white light emitting diode.

Optical devices such as illumination devices or display devices in which a light emitting diode (hereinafter “LED”), especially a white LED is employed are used in a wide range of fields. However, in such devices, an LED element is mounted on a circuit pattern on a substrate by a conductive adhesive, solder or the like, and the required connections are formed by wire bonding. Therefore, to increase the light utilization, ratio of the LED, a reflector (reflection frame) is provided around the LED element. The LED element located within the reflector is sealed with a transparent resin. While various kinds of white LED are known, typical examples include an LED which obtains white by combining a plurality of LEDs such as green (G), blue (B), and red (R), and an LED which utilizes the effects of wavelength conversion by adding a fluorescent material into the sealing resin. In the case of wavelength conversion, an ultraviolet emission LED can also be used as a light source. As a reflector, a molded product of a resin composition filled with white pigment particles and the like comprising a metal oxide can be used. Reflectors which include a resin composition require heat resistance against the heat generated during a heating step, such as soldering when mounting the LED element on the substrate, heat generated during thermal curing of the sealing resin, heat applied when bonding the LED device to other parts, heat applied in the environment in which the LED device is used and the like. Furthermore, such reflectors also need to maintain a high reflectance against the light rays during periods of subsequent use. In addition, when a white LED is used, such reflectors especially need to maintain a good reflectance against the light rays in the wavelength region of 500 nm or less. Based on these points, resin compositions formed from a white pigment and a thermotropic liquid crystal polyester having excellent heat resistance, especially a wholly aromatic thermotropic liquid crystal polyester having a melting point above 320° c., are now used for LED reflectors (for example, refer to Patent Documents 1 to 3).

However, molded products formed by injection molding using the resin composition of the above-described patent documents suffer from the problem that the mechanical strength of weld portions is greatly reduced, which in some cases means that such molded products cannot be used as a reflector part to be used in applications requiring mechanical strength. The term “weld portion” refers to the interface portion where a molten resin or resin composition which was flowed from different directions bonds in an injection molding die. Compared with other portions, the mechanical strength tends to be lower.

### SUMMARY

Some embodiments of the present invention provide a resin composition including a wholly aromatic thermotropic liquid crystal polyester and titanium oxide particles, from which a molded product can be obtained which, while maintaining the excellent heat resistance and moldability of the wholly aromatic thermotropic liquid crystal polyester, has good white light reflectance and excellent weld portion mechanical strength. Furthermore, some embodiments of the present invention provide a molded product formed from this resin composition, and an optical device in which this molded product is used.

In view of the above-described problems in the conventional art, as a result of extensive studies, the present inventor discovered that a resin composition having in a specific ratio a wholly aromatic thermotropic liquid crystal polyester, specific titanium oxide particles, glass fibers, and optionally other inorganic fillers, which is obtained by undergoing a melt-kneading step which includes a specific step, can resolve the above-described problems, thereby completed the present invention.

Specifically, a first aspect of the present invention relates to a resin composition which includes 100 parts by mass of a wholly aromatic thermotropic liquid crystal polyester, 8 to 42 parts by mass of titanium oxide particles formed by surface treating 97 to 85 mass % of titanium oxide obtained by a production method which includes a roasting step with 3 to 15 mass % of aluminum oxide (including hydrates) (in which a total of the titanium oxide and the aluminum oxide is 100 mass %), 25 to 50 parts by mass of glass fibers, and 0 to 8 parts by mass of other inorganic fillers, wherein the resin composition is obtained by undergoing a melt-kneading step which includes a step of feeding at least a part of the glass fibers using a twin screw extruder from a position which is 30% or more downstream based on a total length of a cylinder of the twin screw extruder.

A second aspect of the present invention relates to a resin composition characterized in that, in the first aspect of the present invention, the titanium oxide is obtained by a sulfuric acid method.

A third aspect of the present invention relates to a resin composition characterized in that, in the first or second aspect of the present invention, a light reflectance at 480 nm on a surface of a test piece having a thickness of 3 mm formed by injection molding is 70% or more, and a weld portion strength of a test piece having a thickness of 1 mm formed by injection molding is 30 MPa or more.

A fourth aspect of the present invention relates to a molded product obtained from the resin composition of any of the first to third aspects of the present invention by injection molding, which has a molded surface with a light reflectance at 480 nm of 70% or more.

A fifth aspect of the present invention relates to an optical device in which the molded product of the fourth aspect of the present invention is used as a member of a light emitting device and/or a reflector.

A sixth aspect of the present invention relates to an optical device characterized in that, in the fifth aspect of the present invention, the light emitting device uses a white LED.

According to the present invention, a resin composition which can provide a molded product having excellent white light reflectance and weld portion strength can be obtained without impairing the excellent heat resistance and moldability of the wholly aromatic thermotropic liquid crystal polyester. As a result, using the surface of an injection molded product of this resin composition as a reflecting surface, a reflector can be obtained which also has excellent mechanical strength, especially a reflector which is suited to a white LED. Furthermore, a light emitting device having excellent performance can be provided.

### DETAILED DESCRIPTION

### Concerning the Wholly Aromatic Thermotropic Liquid Crystal 20 Polyester

The wholly aromatic thermotropic liquid crystal polyester according to the present invention is not especially limited. However, since heat resistance, such as solder resistance, is required to use as an LED reflector, the wholly aromatic thermotropic liquid crystal polyester preferably has a melting point of 320° C. or more.

To obtain a wholly aromatic thermotropic liquid crystal polyester with a melting point of 320° C. or more, it is preferred to use 40 mole % or more of p-hydroxybenzoic acid as a raw material monomer. In addition, other known aromatic hydroxycarboxylic acids, aromatic dicarboxylic acids, and aromatic dihydroxy compounds may be appropriately combined and used. Preferred examples thereof include polyesters obtained only from aromatic hydroxycarboxylic acids such as p-hydroxybenzoic acid and 2-hydroxy-6-naphthoic acid, and liquid crystal polyesters obtained from such polyesters and an aromatic dicarboxylic acid such as terephthalic acid, isophthalic acid, and 2,6-naphthalenedicarboxylic acid and/or an aromatic dihydroxy compound such as hydroquinone, resorcin, 4,4′-dihydroxydiphenyl, and 2,6-dihydroxynaphthalene.

Especially preferred are wholly aromatic thermotropic liquid crystal polyesters obtained by polycondensation of 80 to 100 mole % of p-hydroxybenzoic acid (I), terephthalic acid (II), and 4,4′-dihydroxybiphenyl (III) (including derivatives thereof) (in which the total of (I) and (II) is 60 mole % or more) and 0 to 20 mole % of other aromatic compounds capable of a polycondensation reaction with any of (I), (II), and (III).

The wholly aromatic thermotropic liquid crystal polyester is preferably produced by carrying out melt polycondensation after the hydroxyl groups of the monomer have been acetylated in advance. This is done to shorten the melt polycondensation time and reduce the effects of thermal history during the steps. Furthermore, to simplify the steps, it is preferred to carry out the acetylation by feeding acetic anhydride to the monomer in the reactor, and to carry out this acetylation step using the same reactor as the melt polycondensation step. Namely, it is preferred to carry out the acetylation reaction with the raw material monomer and acetic anhydride in the reactor, and when the reaction finishes, increase the temperature and move onto the polycondensation reaction.

The melt polycondensation reaction is carried out along with a deacetylation reaction of the acetylated monomer. It is preferred to use a reactor which has monomer feeding means, acetic acid discharge means, molten polyester extraction means, and stirring means. Such a reactor (polycondensation apparatus) may be appropriately selected from among known tanks. The polymerization temperature is preferably 150 to 350° C. After the acetylation reaction finishes, the temperature is increased to the polymerization starting temperature to start the polycondensation. It is preferred to then increase the temperature in the range of 0.1° C./min to 2° C./min until increasing to a final temperature of 280 to 350° C. Catalysts which are known as polyester polycondensation catalysts can be used in the reaction. Specific examples thereof may include metal catalysts such as magnesium acetate, stannous acetate, tetrabutyl titanate, lead acetate, sodium acetate, and potassium acetate, and organic compound catalysts such as N-methylimidazole. The polycondensation temperature also increases in conjunction with the increase in the melt temperature of the polymer generated as the polycondensation proceeds.

In the melt polycondensation, when the pour point reaches 200° C. or more, and preferably 220 to 330° C., a wholly aromatic thermotropic liquid crystal polyester with a low degree of polymerization is extracted from the polymerization tank in a melt state as is, and is then fed to a cooling machine such as a steel belt or a drum cooler to be cooled down and solidified.

Next, the solidified wholly aromatic thermotropic liquid crystal polyester with a low degree of polymerization is ground to a size which is appropriate for the subsequent solid phase polycondensation reaction. The grinding method is not especially limited. Preferred examples of such a method which can be used include using an impact crusher, such as a feather mill, a Victory mill, a Kolloplex, a pulverizer, a Contraplex, a scroll mill, an ACM pulverizer and the like manufactured by Hosokawa Micron Group, and using an apparatus such as a roll granulator, which is a cross-linking and crushing type crusher manufactured by Matsubo Corporation. Especially preferred is a method using a feather mill manufactured by Hosokawa Micron Group. In the present invention, the particle size of the ground product is not especially limited. However, using an industrial sieve (Tyler mesh), a particle size in a range which passes through a 4 mesh but does not pass through a 2,000 mesh is preferred, in a range between a 5 mesh and a 2,000 mesh (0.01 to 4 mm) is more preferred, and in a range between a 9 mesh and a 1,450 mesh (0.02 to 2 mm) is the most preferred.

Next, the ground product obtained in the grinding step is supplied to the solid phase polycondensation step, and solid phase polycondensation is carried out. The apparatus and operation conditions used in the solid phase polycondensation step are not especially limited. A known apparatus and method may be used. To use as an LED reflector, it is preferred to carry out the solid polycondensation reaction until a product having a melting point of 320° C. or more is obtained.

### Concerning the Titanium Oxide Particles:

In the present invention, titanium oxide particles are used as a white pigment. The titanium oxide particles are formed by surface treating 97 to 85 mass % of titanium oxide obtained by a production method which includes a roasting step with 3 to 15 mass % of aluminum oxide (including hydrates) (in which the total of the titanium oxide and the aluminum oxide is 100 mass %).

As the titanium oxide obtained by a production method which includes a roasting step, it is preferred to use a rutile-type titanium oxide which has a large hiding power and a number average particle size in the range of 0.1 to 0.5 μm. Furthermore, a titanium oxide produced by a sulfuric acid method which includes a roasting step is especially preferred. The present inventor believes that the excellent effects gained by using such titanium oxide particles are due to the component which has an adverse effect on the white light reflectance of the molded product of the resin composition obtained by adding the titanium oxide particles to a wholly aromatic thermotropic liquid crystal polyester and then melt-kneading the resultant mixture, being removed by the roasting step.

The surface treatment of the titanium oxide with aluminum oxide may be carried out using a known method. For example, the method described in Japanese Patent Application Laid-Open No. Hei. 5-286721 may be used. Alternatively, a method described as, a conventional method in such publication may also be used. The titanium oxide particles surface treated by aluminum oxide may also be commercially available. An example of such a commercially-available product is “SR-1” (rutile-type titanium oxide, number average particle size of 0.25 μm, surface treatment agent Al₂O₃, 'treated amount 5%) manufactured by Sakai Chemical Industry Co., Ltd.

When the amount of aluminum oxide used for surface treatment of the titanium oxide is 3 mass % or less of the total amount of the titanium oxide and the aluminum oxide, the effects of coating the surface of the titanium oxide cannot be sufficiently exhibited. On the other hand, when such amount exceeds 15 mass %, problems with handleability can occur, due to agglomeration of the titanium oxide particles or the like. Thus, titanium oxide particles formed by surface treating 97 to 85 mass % of titanium oxide with 3 to 15 mass % of aluminum oxide (in which the total of the titanium oxide and the aluminum oxide is 100 mass %) are used. A particularly preferred range of the aluminum oxide ratio is 5 to 10 mass %.

The added amount of the titanium oxide particles is 8 to 42 parts by mass, and preferably 13 to 40 parts by mass, based on 100 parts by mass of the wholly aromatic thermotropic liquid crystal polyester. When the added amount is less than the lower limit, it tends to be difficult to obtain sufficient whiteness. On the other hand, when the added amount exceeds the upper limit, the mechanical strength of the weld portion of the molded product obtained by injection molding of the obtained resin composition tends to decrease, so that it tends to be difficult to use such molded product as a reflector part application requiring mechanical strength.

### Concerning the Glass Fibers:

Examples of glass fibers which may be preferably used in the present invention include glass fibers which are used as a common resin reinforcing material, such as chopped strands, milled fibers and the like. However, chopped strands are preferred. The number average length of the used glass fibers is 100 μm to 10 mm, preferably 200 μm to 5 mm, and more preferably 1 mm to 5 mm. From the perspective of fluidity during the injection molding, the diameter of the glass fibers is preferably a number average size of 5 to 20 μm, and more preferably of 7 to 15 μm. Preferred specific examples include “PX-1” (number average fiber size 10 μm, number average fiber length 3 mm) manufactured by Owens Corning Japan Ltd., and the like.

The added amount of the glass fibers is 25 to 50 parts by mass based on 100 parts by mass of the wholly aromatic thermotropic liquid crystal polyester. When the 'added amount is less than this lower limit, the mechanical strength of the weld portion of the molded product obtained by injection molding of the obtained resin composition tends to be insufficient. On the other hand, when the added amount exceeds this upper limit, this means that the added amount of the wholly aromatic thermotropic liquid crystal polyester and/or the titanium oxide particles is relatively reduced, so that the moldability and/or the whiteness of the obtained resin composition tends to be insufficient.

### Concerning Other Inorganic Fillers:

To the extent that the effects of the present invention are not impaired, the resin composition of the present invention may also contain known inorganic fillers. Examples of inorganic fillers include silicates such as talc, quartz powder, glass powder, calcium silicate, and aluminum silicate, alumina, calcium sulfate and the like. These may be used alone or two kinds or more may be used.

The added amount of the other inorganic fillers is 0 to 8 parts by mass based on 100 parts by mass of the wholly aromatic thermotropic liquid crystal polyester. When the added amount exceeds the upper limit, this means that the added amount of the wholly aromatic thermotropic liquid crystal polyester and/or the titanium oxide particles and/or the glass fibers is relatively reduced, which tends to cause problems such as that moldability and/or whiteness decrease, and the effects of an improvement in the mechanical strength of the weld portion of the molded product cannot be sufficiently obtained.

### Concerning the Production Method of the Resin Composition:

In the production of the resin composition of the present invention, a twin screw extruder is used as the apparatus for melt-kneading the wholly aromatic thermotropic liquid crystal polyester, the titanium oxide particles, the glass fibers, and the optional other inorganic fillers. More preferably, the apparatus is a continuous-extrusion type twin screw extruder having a pair of double-threaded screws. Among such mixers, the resin composition of the present invention can be efficiently obtained by using a co-rotational type having a cutback mechanism which enables uniform dispersion of the filler material, a cylinder diameter of 40 mmφ or more with a large gap between the barrel and the screws which allows the filler material to be easily cut into, a contact ratio of 1.45 or more with a large gap between screws, and which can feed the filler material from midway along the cylinder. Furthermore, such extruder may also have a device for feeding at least a part of the glass fibers midway along the cylinder.

The wholly aromatic thermotropic liquid crystal polyester, the titanium oxide particles, and the optionally-used other inorganic fillers are preferably mixed using a known solid mixing apparatus, for example a ribbon blender, a tumbler blender, a Henschel mixer and the like, optionally dried by a hot air dryer, vacuum dryer and the like, and then fed from the hopper of the twin screw extruder.

In the production of the resin composition of the present invention, at least a part of the mixed glass fibers is fed from midway along the cylinder of the twin screw extruder (so-called side feeding). As a result, the mechanical strength of the weld portion of the molded product molded by injection molding of the obtained resin composition tends to be improved as compared with when feeding all of the glass fibers together with the other raw materials from the hopper (so-called top feeding). The ratio of glass fibers which are side fed with respect to the total amount of glass fibers to be mixed is preferably 50% or more, and the most preferably 100%. When the ratio of glass fibers which are side fed is less than the lower limit, the improvement in mechanical strength of the weld portion of the molded product molded by injection molding of the obtained resin composition tends to be insufficient.

The position midway along the cylinder of the twin screw extruder for feeding the glass fibers by side feeding is a position which is 30% or more downstream from where the hopper is located with respect to the total cylinder length (distance between the position where the hopper is located on the cylinder and the cylinder tip). At this position of the cylinder, the wholly aromatic thermotropic liquid crystal polyester is in a molten state. If the position midway along the, cylinder from which the glass fibers are fed is upstream of the above-described position (on the side where the hopper is located), breakage of the mixed glass fibers becomes marked. This means that the improvement in mechanical strength of the weld portion of the molded product formed by injection molding of the obtained resin composition tends to be insufficient.

Various techniques exist to reduce the breakage of the glass fibers, such as adjusting the screw rotation, deepening the screw grooves and the like. However, when employing these techniques, it is difficult to uniformly mix a large amount of titanium oxide particles like in the present invention. Therefore, from the perspective of uniform mixing of the titanium oxide particles, it is necessary to avoid such techniques, and set the operation conditions of the extruder conversely to break the glass fibers more easily.

Accordingly, in the present invention, to achieve uniform mixing of the titanium oxide and the glass fibers while reducing the breakage of the glass fibers, in the production of the resin composition of the present invention a twin screw extruder with good mixing efficiency is employed, and the above-described specific feeding method is used, namely, so-called side feeding in which at least a part of the glass fibers to be mixed is fed from a specific position midway along the cylinder of the twin screw extruder.

### Resin Composition Characteristics:

The light reflectance (relative reflectance for when the diffuse reflectance of a barium sulfate standard white plate is taken as 100%) at 480 nm on a surface of a flat test piece having a thickness of 3 mm obtained by injection molding under standard conditions from the resin composition of the present invention using a standard die is preferably 70% or more, and more preferably is 75% or more. When this reflectance is less than the lower limit, it tends to be difficult for the molded product obtained from the resin composition to satisfy the reflectance performance which is required for a reflector. The bending strength of a flat test piece having a weld portion with a thickness of 1 mm obtained by injection molding under standard conditions from the resin composition of the present invention using a standard die is preferably 30 MPa or more. When the bending strength of the weld portion in the test piece is less than this value, it tends to be difficult to. use a molded product obtained from the resin composition in reflector applications and the like which require mechanical strength. Furthermore, if the bending strength of the weld portion in the test piece is about 45 MPa, such a molded product can probably be used in the most applications requiring strength within an envisaged range.

### EXAMPLES

The present invention will now be described in more detail with the following examples and comparative examples. However, the present invention is not limited to the following examples.

### Production Example

### Production of Thermotropic Liquid Crystal Polyester

### Melt Polycondensation

298.3 kg of p-hydroxybenzoic acid (2.16 kilomoles) (manufactured by Ueno Fine Chemicals Industry), 134.1 kg of 4,4′-dihydroxydiphenyl (0.72 kilomoles) (manufactured by Honshu Chemical Industry), 89.7 kg of terephthalic acid (0.54 kilomoles) (manufactured by Mitsui Chemicals Inc.), 29.9 kg of 25 isophthalic acid (0.18 kilomoles) (manufactured by A.G. International Chemical Co., Inc.), and 0.11 kg of magnesium acetate (manufactured by Kishida Chemical Co., Ltd.) and 0.04 kg of potassium acetate (manufactured by Kishida Chemical Co., Ltd.) as a catalyst were charged into a reactor having a 1.7 m³ internal volume and made of SUS316L (stainless steel) which had a double-helical stirring blade. The polymerization tank was purged with nitrogen by twice injecting nitrogen under vacuum, and then charged with 385.9 kg of acetic anhydride (3.78 kilomoles). An acetylation reaction was then carried out for 2 hours under reflux at a stirring blade revolution speed of 45 rpm in which the temperature was increased to 150° C. over 1.5 hours. After the acetylation reaction finished, the acetic acid was distilled off. In that state, the temperature was increased by a rate of 0.5° C./min to 310° C., and a polycondensation reaction was carried out for 5 hours and 20 minutes while removing the generated acetic acid.

Next, about 480 kg of the wholly aromatic thermotropic liquid crystal polyester with a low degree of polymerization, which is the melt polycondensation reaction product in the reactor, was extracted from an extraction port at a lower portion of the reactor, and fed to the below-described cool solidifying device. The temperature of the melt polycondensation reaction product at this stage was 310° C.

### Cooling-Solidifying Step:

As the cooling-solidifying device, an apparatus having a pair of cooling rolls (distance between rolls: 2 mm) with a diameter of 630 mm and a pair of weirs with a distance of 1,800 mm was used according to the method described in Japanese Patent Application Laid-Open No. 2002-179779. The pair of cooling rolls was rotated in opposite directions at a speed of 18 rpm. The fluid-state melt polycondensation reaction product extracted from the polymerization reactor was gradually fed to a concave portion formed by the pair of cooling rolls and the pair of weirs. While holding the fluid-state melt polycondensation product in the concave portion, the roll surface temperature was adjusted by adjusting the flow rate of cooling water in the pair of cooling rolls. As a result, after passing between the rolls, the surface temperature of the cooled and solidified wholly aromatic thermotropic liquid crystal polyester with a low degree of polymerization was made to be 220° C. The obtained sheet-like solidified product with a thickness of 2 mm was pulverized into roughly 50 mm squares by a pulverizing machine (manufactured by Nikku Industry Co., Ltd.).

### Grinding Step and Solid Phase Polycondensation Step:

The pulverized product was ground by a feather mill manufactured by Hosokawa Micron Group to obtain a raw material for solid phase polycondensation. The ground product had been passed through a mesh with 1 mm openings. The ground product was put in a rotary kiln, and the temperature of the kiln was increased under a nitrogen flow over 3 hours from room temperature to 170° C., and then over 5 hours to 280° C. The temperature was further increased over 3 hours to 3000 to carry out solid-phase polycondensation, whereby about 480 kg of a wholly aromatic thermotropic liquid crystal polyester was obtained. The melting point of the obtained wholly aromatic thermotropic liquid crystal polyester measured by DSC was 352° C.

### Titanium Oxide Particles:

A 95%/5% titanium oxide/aluminum oxide mass composition mixture having a number average particle size of 0.25 μm was used. This mixture was obtained by subjecting rutile-type titanium oxide obtained by a sulfuric acid method including a roasting step to a surface treatment with aluminum oxide (trade name: SR-1, manufactured by Sakai Chemical Industry Co., Ltd.)

### Glass Fibers:

Used was “PX-1” (number average length 3 mm, number average size 10 μm) manufactured by Owens Corning Japan Ltd.

### Talc:

Used was “MS-KY” (number average particle size 23 μm) manufactured by Nippon Talc Co., Ltd.

### Example 1

### Production of Resin Composition

100 parts by mass of the wholly aromatic thermotropic liquid crystal polyester obtained in the above production example and 42 parts by mass of titanium oxide particles were premixed using a ribbon blender. This mixture was fed from the hopper of a twin screw extruder (KTX-46 manufactured by Kobe Steel Ltd.). Furthermore, based on 100 parts by mass of the wholly aromatic thermotropic liquid crystal polyester to be fed from this hopper, the feeder was adjusted so that 25 parts by mass of glass fibers was fed midway along the cylinder (side fed) of the twin screw extruder. The mixture was then melt-extruded at a cylinder maximum temperature of 430° C. to obtain a pellet. The position of the cylinder of the twin screw extruder from which the glass fibers were side fed was a position 50% on the cylinder tip side from the position where the hopper was located with respect to the length between the position where the hopper was located on the cylinder and the cylinder tip.

### Preparation of Test Piece by Injection Molding:

A 30 mm (width)×60 mm (length)×3.0 mm (thickness) flat plate injection molded product was obtained at a cylinder maximum temperature of 420° C., an injection rate of 100 mm/sec, and a die temperature of 80° C. from a pellet of the obtained resin composition using an injection molding machine (SG-25 manufactured by Sumitomo Heavy Industries, Ltd.). This flat plate injection molded product was used as a white light reflectance test piece. Similarly, a 13 mm (width)×80 mm (length) 1.0 mm (thickness) flat plate injection molded product with a weld portion at its center was obtained at a cylinder maximum temperature of 420° C., an injection rate of 300 mm/sec, and a die temperature of 80° C. from a pellet of the obtained resin composition using an injection molding machine (UH-1000 manufactured by Nissei Plastic Industrial Co., Ltd.). This flat plate injection molded product was used as a test piece for weld portion strength measurement.

### Measurement of White Light Reflectance:

The diffuse reflectance of light with a wavelength of 480 nm on the surface of the respective test pieces was measured using a recording spectrophotometer (U-3500: manufactured by Hitachi, Ltd.). Here, reflectance is a relative value when the diffuse reflectance of a barium sulfate standard white plate was taken as 100%. The results are shown in Table 1.

### Measurement of Weld Portion Strength:

The weld portion strength for each of the test pieces was measured in accordance with ASTM D790 at a span interval of 25 mm.

### Examples 2 to 6

The respective resin compositions having the compositions shown in Table 1 were produced by the same operational method as in Example 1. In Example 5, the talc was premixed with the titanium oxide particles and the wholly aromatic thermotropic liquid crystal polyester, and then fed from the hopper. Furthermore, in Example 6, half of the glass fibers was premixed with the titanium oxide particles and the wholly aromatic thermotropic liquid crystal polyester, then fed from the hopper (top feeding), and the remaining half was side fed. The respective test pieces were prepared by injection molding in the same manner as in Example 1 using a pellet of the obtained respective resin compositions. The diffuse reflectance of light with a wavelength of 480 nm and the weld portion strength were measured. The results are shown in Table 1.

### Comparative Examples 1 to 5

Resin compositions having the compositions shown in Table 1 were produced by the same operational method as in Example 1. However, in each example, the glass fibers were fed by the method described in Table 1. More specifically, the glass fibers were fed by top feeding which means by premixing with the titanium oxide particles and the wholly aromatic thermotropic liquid crystal polyester, and feeding from the hopper or side feeding. The respective test pieces were produced by injection molding in the same manner as in Example 1 using a pellet of the obtained respective resin compositions. The diffuse reflectance of light with a wavelength of 480 nm and the weld portion strength were measured. The results are shown in Table 1.

The compositions of Examples 1 to 6, which were formed from the composition and the production steps of the present invention, all had excellent moldability, light reflectance, and weld portion strength. In contrast, when the added amount of titanium oxide particles was less than the lower limit of the range of the present invention (Comparative Example 1), light reflectance decreased, and when the added amount of titanium oxide particles exceeded the upper limit (Comparative Example 2), weld portion strength decreased. Moreover, when the added amount of glass fibers was less than the lower limit of the range of the present invention (Comparative Example 3), weld portion strength decreased, and when the added amount of glass fibers exceeded the upper limit (Comparative Example 4), problems occurred with moldability (flowability). Furthermore, when the whole amount of the glass fibers was top fed during the production of the resin composition (Comparative Example 5), weld portion strength was low.

TABLE 1

| | | Titanium | | | | | | |
|---|---|---|---|---|---|---|---|---|
| | LCP*¹ | Oxide | Talc | Glass Fibers | | 480 nm | Weld | |
| | (parts | particles | (parts | (parts by mass) | | Light | Portion | |
| | by | (parts by | by | Top | Side | Reflectance | Strength | |
| Example | mass) | mass) | mass) | Feeding | Feeding | (%) | (MPa) | Moldability*² |
| Example 1 | 100 | 42 | | | 25 | 82 | 32 | ⊚ |
| Example 2 | 100 | 33 | | | 33 | 81 | 34 | ⊚ |
| Example 3 | 100 | 25 | | | 42 | 78 | 36 | ⊚ |
| Example 4 | 100 | 17 | | | 50 | 76 | 38 | ⊚ |
| Example 5 | 100 | 9 | 8 | | 50 | 73 | 43 | ⊚ |
| Example 6 | 100 | 17 | | | 25 | 76 | 33 | ⊚ |
| Comparative | 100 | 4 | 8 | | 50 | 68 | 39 | ⊚ |
| Example 1 | | | | | | | | |
| Comparative | 100 | 50 | | 25 | 25 | 83 | 28 | ◯ |
| Example 2 | | | | | | | | |
| Comparative | 100 | 42 | 8 | | 17 | 82 | 25 | ◯ |
| Example 3 | | | | | | | | |
| Comparative | 100 | 8 | | | 60 | 72 | 45 | Δ |
| Example 4 | | | | | | | | |
| Comparative | 100 | 33 | | 33 | | 81 | 20 | ⊚ |
| Example 5 | | | | | | | | |

*¹LCP: Wholly Aromatic Thermotropic Liquid Crystal Polyester
*²Double circle: Excellent, Circle: Good. Triangle: Some Problems

### INDUSTRIAL APPLICABILITY

The resin composition of the present invention can maintain the excellent heat resistance and injection moldability that a thermotropic liquid crystal polyester resin has. The molded product obtained by injection molding the above resin composition has excellent white light reflectance and weld portion strength. Therefore, this molded product can be used as a part for which a high reflectance and mechanical strength are required, such as a member of a light emitting device and/or a reflector, and especially for when the light emitting device uses a white LED.

1. A resin composition comprising:
100 parts by mass of a wholly aromatic thermotropic liquid crystal polyester;
8 to 42 parts by mass of titanium oxide particles formed by surface treating 97 to 85 mass % of titanium oxide obtained by a production method which includes a roasting step with 3 to 15 mass % of aluminum oxide (including hydrates) (in which a total of the titanium oxide and the aluminum oxide is 100 mass %);
25 to 50 parts by mass of glass fibers; and
0 to 8 parts by mass of other inorganic fillers, wherein the resin composition is obtained by undergoing a melt-kneading step which includes a step of feeding at least a part of the glass fibers using a twin screw extruder, which has a cylinder, from a position which is 30% or more downstream based on a total length of the cylinder of the twin screw extruder.

2. The resin composition according to claim 1, wherein the titanium oxide is obtained by a sulfuric acid method.

3. The resin composition according to claim 1 or 2, wherein a light reflectance at 480 nm on a surface of a test piece having a thickness of 3 mm molded by injection molding is 70% or more, and a weld portion strength of a test piece having a thickness of 1 mm molded by injection molding is 30 MPa or more.

4. A molded product obtained from the resin composition according to any of claims 1 to 3 by injection molding, which has a molded surface with a light reflectance at 480 nm of 70% or more.

5. An optical device, using the molded product according to claim 4 as a member of a light emitting device and/or a reflector.

6. The optical device according to claim 5, wherein the light emitting device uses a white LED.
